(19) United States
(12) Patent Application Publication
(10) Pub. No.: US 2024/0291288 A1
(43) Pub. Date: Aug. 29, 2024

(54) AUTOMATIC HIGH-POWER ELECTRICAL ENERGY ENERGY STORAGE SYSTEMS AND MANAGEMENT METHODS

(71) Applicant: Wright Energy Storage Technologies, Inc., New York, NY (US)

(72) Inventor: William De Jong, Gordon's Bay (ZA)

(73) Assignee: Wright Energy Storage Technologies, Inc., New York, NY (US)

(21) Appl. No.: 18/571,900

(22) PCT Filed: Jul. 17, 2022
(86) PCT No.: PCT/US22/37410

§ 371 Date: Dec. 19, 2023

Related U.S. Application Data
(60) Provisional application No. 63/222,971, filed on Jul. 17, 2021.

(51) Int. Cl. H02J 7/00

(52) U.S. Cl. CPC H02J 7/0014; H02J 7/0029; H02J 7/0042; H02J 7/0047; H02J 7/007182; H02J 2207/50

(57) ABSTRACT

An energy storage device for safely storing and delivering energy includes a charge storage assembly that includes an array of high-power energy storage devices, a protective device for controlling a flow of the energy, a current limiting charging device to limit a current flowing into the charge storage assembly, a passive balancing circuit to balance the energy of the charge storage assembly and a software and hardware processing system to control one or more of the protective device, the current limiting charging device, and the passive balancing circuit.

### CLAIM OF PRIORITY

This application claims the benefit of the earlier filing date of that provisional patent application filed in the US Patent and Trademark Office on Jul. 17, 2021 and afforded Ser. No. 63/222,971, the contents of which are incorporated in their entirety, herein.

### TECHNICAL FIELD

The present disclosure generally relates to high-power energy storage devices, particularly those which utilize supercapacitor, electric double-layer capacitors (EDLC), hybrid capacitors, pseudo-capacitors, or other high-power energy storage devices.

### BACKGROUND

In recent years, an increasing focus has been placed on systems that supply energy from renewable generation sources. This focus has placed an emphasis on converting systems from fossil fuel-based power generation to those that run on electrical energy, including mobile systems such as electric vehicles and consumer devices, as well as stationary systems from large-scale grid generation to smaller home systems.

Additionally, aging electric infrastructure, changes and growth in energy usage patterns, and advances in renewable generation and power management equipment has enabled the construction of a global energy delivery system which relies purely on clean, renewable, and efficient electricity sources.

This migration from fossil-fuel-based systems to clean electricity sources necessitates the existence of safe, long-lasting, efficient, reliable, and cost-efficient methods for storage of electrical energy. While non-chemical electrical energy storage devices offer great promise as a scalable solution to this dilemma, they are capable of releasing large quantities of energy rapidly and can damage themselves and other equipment if not managed properly.

Hence, they must be carefully controlled so that they can deliver power safely, reliably, and in a manner which allows them to realize their potential as a long-lived, scalable solution to the enormous task of converting the planet from its dependency on systems that run on fossil fuel, to ones that are truly clean and efficient.

### SUMMARY

Wherefore, it is an object of the present invention to overcome the above-mentioned shortcomings and drawbacks associated with the current technology.

The invention relates to methods of intelligently storing energy and intelligent energy storage devices comprising a charge storage assembly disposed on an electric circuit, at least one processor disposed on the electric circuit. According to a further embodiment, a passive balancing circuit disposed on the electric circuit and functionally connected to the at least one processor. According to a further embodiment, a protection device disposed on the electric circuit between a pair of terminal posts and the charge storage assembly, the pair of terminal posts having a positive terminal post and a negative terminal post. According to a further embodiment, a current limiting charging device is disposed on the electric circuit parallel to the protection device. According to a further embodiment, a current measurement assembly including a current sensor disposed on the electric circuit between the negative terminal post and the charge storage assembly. According to a further embodiment, a first voltage measurement assembly including a voltage sensor measuring voltage across the charge storage assembly. According to a further embodiment, a second voltage measurement assembly including a voltage sensor measuring voltage in the passive balancing circuit. According to a further embodiment, a third voltage measurement assembly including a voltage sensor measuring a voltage across the terminal posts. According to a further embodiment, a selector circuit (e.g. ‘OR’ gate) operatively coupled between the at least one processor and the current limiting charging device such that one input terminal of the ‘OR’ gate is connected to the at least one processor, another input terminal of the ‘OR’ gate is connected to at least one of the first voltage measurement assembly, the third voltage measurement assembly, and both the first voltage measurement assembly and the third voltage measurement assembly, and an output terminal of the ‘OR’ gate is connected to the current limiting charging device. According to a further embodiment, a main breaker is disposed on the circuit between the negative terminal and the current measurement assembly. According to a further embodiment, the current measurement assembly is a shunt based current sensor. According to a further embodiment, charge storage assembly includes a plurality of strings. According to a further embodiment, the term string includes a plurality of high-power energy storage devices that are connected in parallel. According to a further embodiment, the ‘high-power energy storage device’ may relate to, for example, a supercapacitor, an electric double-layer capacitor (EDLC), a hybrid capacitor, a pseudo-capacitor, or a combination thereof leading to high-power storage system. According to a further embodiment, each string corresponds to an element in the array of the charge storage assembly. According to a further embodiment, the plurality of strings may be connected in series to formulate the charge storage assembly as the array of the high-power energy storage devices. According to a further embodiment, the at least one processor is embodied as one or more of various hardware processing modules such as a coprocessor, a microprocessor, a controller, a digital signal processor (DSP), a processing element with or without an accompanying DSP, or various other processing circuitry including integrated circuits such as, for example, an ASIC, an FPGA, a microcontroller unit (MCU), a hardware accelerator, a special-purpose computer chip, or the like. According to a further embodiment, the at least one processor 103 may be a computer chip that includes a microcontroller with SPI (Serial Peripheral Interface), UART (Universal Asynchronous Receiver/Transmitter) and any other relevant interfaces that are known in the art. According to a further embodiment, the computer chip further includes one or more of a crypto authenticator for network key security, one or more IoT devices such as Bluetooth, Wi-Fi, and SPI. According to a further embodiment, the computer chip may include a current measurement chip, a push button interface, at least one user interface LED (Light Emitting Diode). According to a further embodiment, the at least one processor is operatively coupled with a memory storing a system safety module. According to a further embodiment, the memory is embodied as one of SD (Secure Digital), RAM (Random Access Memory), ROM (Read Only Memory), hard-disk, or any combination thereof. According to a further embodiment, the system safety module is a set of instructions (e.g., a software code), executed by the at least one processor. According to a further embodiment, the at least one processor is configured to perform algorithms and operations described herein, such as controlling one or more units in the intelligent energy storage device. According to a further embodiment, the at least one processor may be operatively coupled to the one or more units, and one or more units may include the protection device, the current limiting charging device, the user interface module, and/or the external input module. According to a further embodiment, the term ‘control’ may refer to, for example, switching on/off one or more of the referred to elements or configuring the elements to perform according to its corresponding operations described herein. According to a further embodiment, the protection device may be a switching device that is operatively connected (e.g., electronically) between the terminal post and the charge storage assembly and the terminal posts are electrical connectors. According to a further embodiment, the electrical connectors are used to connect a power supply and/or a load to the intelligent energy storage device for charging or discharging the charge storage assembly. According to a further embodiment, the invention further relates to a method for operating an intelligent storage device. According to a further embodiment, the protection device is configured to prevent or allow, according to a first control input received from the at least one processor, a safe flow of the electrical energy into (or out of) the charge storage assembly through the protection device. According to a further embodiment, while charging the charge storage assembly or discharging the charge storage assembly, the protection device allows or does not allow the electrical energy to flow into the charge storage assembly based on the first control input received from the at least one processor. According to a further embodiment, the first control input is a digital signal received from the at least one processor. According to a further embodiment, the digital signal is a sequence of bits. According to a further embodiment, upon executing the system safety module, the at least one processor determines the first control input for the protection device. According to a further embodiment, the protection device includes a SSR (Solid State Relay). According to a further embodiment, the protection device includes MOSFET (metal-oxide-semiconductor field-effect transistor) drivers, MOSFETs, and one or more heat sink circuits. According to a further embodiment, the current limiting charging device is connected in parallel to the protection device. According to a further embodiment, the safe operating level for discharging the charge storage assembly is specified or predetermined based on the configuration of the charge storage assembly. According to a further embodiment, the current limiting charging device is operatively coupled between the charge storage assembly and the terminal posts. According to a further embodiment, the current limiting charging device is configured to limit (step-down) a voltage from the power supply such that a limited current is drawn from a power supply connected to the storage device. According to a further embodiment, upon executing the system safety module, the at least one processor is configured to determine a second control input signal; and control, according to the second control input signal, the current limiting charging device to limit the voltage from the power supply such that a limited current is drawn from the power supply. According to a further embodiment, the second control input signal is a digital signal. According to a further embodiment, the current limiting charging device is configured to check if there is a short circuit in the terminal posts to avoid damage to the intelligent energy storage device. According to a further embodiment, the current limiting charging device includes a buck converter with a predefined current limit. According to a further embodiment, the current limiting charging device includes MOSFETs, capacitors, and inductors that formulate the buck converter with the predefined current limit. According to a further embodiment, the current limiting charging device includes MOSFET drivers, PCB (Printed Circuit Board) embedded heat sink, or the like. According to a further embodiment, the current limiting charging device includes an in-built charging device that supplies the current of the predefined current limit. According to a further embodiment, the current limiting charging device supplies the current of the predefined current limit, when the charge storage assembly discharges below the safe operating level.

The present disclosure describes systems and methods of balancing and controlling the flow of electricity in a device such that the device operates in a way it can store and deliver electric power within the physical capabilities of all system components safely and without harm to its individual parts.

The present disclosure provides an intelligent energy storage device having a charge storage assembly including an array of high-power energy storage devices, a protective device, such as a solid state relay (SSR), a current limiting charging device to passively provide reduced voltage and current (i.e., lower power) charge to or from the storage assembly, a software and hardware processing system to control these processes and provide user interaction, multiple voltage measurement assemblies, a current measurement assembly, and a passive balancing circuit to manage the voltage differential between strings in series of the storage assembly. Various other devices, including breakers, switches, terminal posts, and indicator lights are included to operate the system, as necessary.

High-power energy storage devices are capable of charging and discharging rapidly and must be designed and constructed in a manner that prevents them from being damaged or damaging nearby equipment. Such damage can occur due to internal and external energy spikes, over-voltage or over-current of the storage assembly, and large voltage variances between systems when connected to external power. The disclosure additionally provides a plurality of charging and discharging methodologies to properly balance the energy storage assembly and protect storage assemblies and sensitive electronic boards from damage.

Various objects, features, aspects, and advantages of the present invention will become more apparent from the following detailed description of preferred embodiments of the invention, along with the accompanying drawings in which like numerals represent like components. The present invention may address one or more of the problems and deficiencies of the current technology discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. It is to be appreciated that the accompanying drawings are not necessarily to scale since the emphasis is instead placed on illustrating the principles of the invention. The present disclosure describes systems and methods of balancing and controlling the flow of electricity such that the device operates in a way it can safely store and deliver electric power in any combination of strings in parallel and series, and within the physical capabilities of all system components safely and without harm to its individual parts. The invention will now be described, by way of example, with reference to the accompanying drawings in which:

FIG. 1 illustrates a block diagram of a high-power electrical energy storage system, in accordance with an example embodiment.

FIG. 2 illustrates a schematic diagram of a charge storage assembly, in accordance with an example embodiment.

FIG. 3 illustrates a process flow of the high-power electrical energy storage system, in accordance with an example embodiment.

FIG. 4 illustrates a flowchart showing a dead module routine in the process flow, in accordance with an example embodiment.

FIG. 5 illustrates a flowchart showing a low voltage routine in the process flow, in accordance with an example embodiment.

FIG. 6 illustrates a flowchart showing a safe-mode charging routine in the low voltage routine, in accordance with an example embodiment.

FIG. 7 illustrates a flowchart showing a safe-mode discharging routine in the low voltage routine, in accordance with an example embodiment.

FIG. 8 illustrates a block diagram showing one or more computations performed by a processor using current measurements, in accordance with an example embodiment.

FIG. 9 illustrates a block diagram showing one or more computations performed by a processor using voltage measurements, in accordance with an exemplary embodiment of the invention.

### DETAILED DESCRIPTION

The present invention will be understood by reference to the following detailed description, which should be read in conjunction with the appended drawings. It is to be appreciated that the following detailed description of various embodiments is by way of example only and is not meant to limit, in any way, the scope of the present invention. In the summary above, in the following detailed description, in the claims below, and in the accompanying drawings, reference is made to particular features (including method steps) of the present invention. It is to be understood that the disclosure of the invention in this specification includes all possible combinations of such particular features, not just those explicitly described. For example, where a particular feature is disclosed in the context of a particular aspect or embodiment of the invention or a particular claim, that feature can also be used, to the extent possible, in combination with and/or in the context of other particular aspects and embodiments of the invention, and in the invention generally. The terms “comprise(s),” “include(s),” “having,” “has,” “can,” “contain(s),” and grammatical equivalents and variants thereof, as used herein, are intended to be open-ended transitional phrases, terms, or words that do not preclude the possibility of additional acts or structures. are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components. The singular forms “a,” “and” and “the” include plural references unless the context clearly dictates otherwise. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40% means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

The embodiments set forth below represent the necessary information to enable those skilled in the art to practice the invention and illustrate the best mode of practicing the invention. For the measurements listed, embodiments including measurements plus or minus the measurement times 5%, 10%, 20%, 50% and 75% are also contemplated. For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

In addition, the invention does not require that all the advantageous features and all the advantages of any of the embodiments need to be incorporated into every embodiment of the invention.

Reference will be made to the figures, showing various embodiments of an intelligent energy storage device. It is an objective of the intelligent energy storage device to safely store energy. To this end, the intelligent energy storage device includes a charge storage assembly. For instance, the charge storage assembly includes an array of high-power energy storage devices. It is also objective of the intelligent energy storage device to control the flow of energy. To this end, the intelligent energy storage device includes the protection device. For instance, the protection device is a switching device that may be turned on/off to prevent damage to the individual components of the intelligent energy storage device and/or other systems that are connected to the intelligent energy storage device.

It is also an objective of the intelligent energy storage device to determine an operative condition associated with the charge storage assembly. To this end, the intelligent energy storage device includes a plurality of voltage measurement assemblies and/or a current measurement assembly. The operative condition may be one of a dead module condition, a low-voltage condition, a normal condition, or an over-voltage condition.

Some embodiments are based on the realization that when the operative condition corresponds to the dead module condition and/or the low-voltage condition, the charge storage assembly is preferably charged with a limited current to prevent damage to the charge storage assembly and/or other components of the intelligent energy storage device. To this end, the intelligent energy storage device includes a current limiting charging device. For instance, the current limiting charging device will supply a limited current to the charge storage assembly.

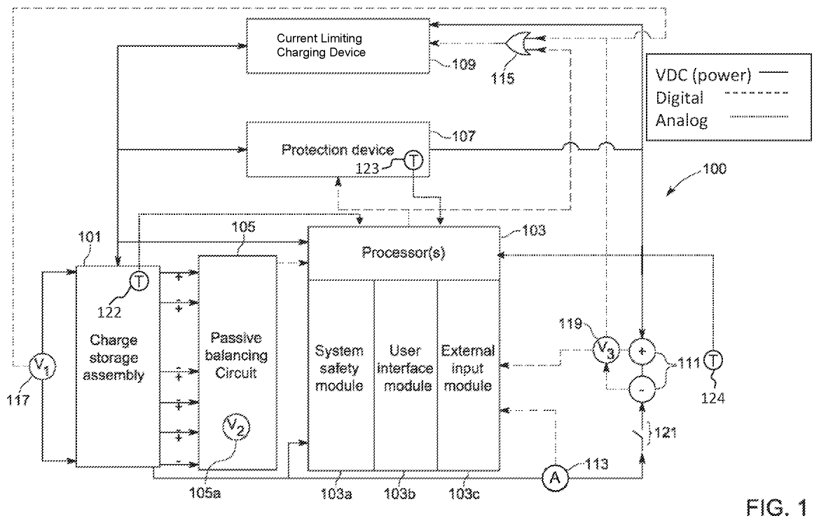

Some embodiments are based on the realization that when the operative condition corresponds to the over-voltage condition, each string of energy storage devices in the charge storage assembly is preferably separately discharged to a safe voltage to prevent damage to the devices in the charge storage assembly and/or other components of the intelligent energy storage device. To this end, the intelligent energy storage device includes a passive balancing circuit. For instance, the passive balancing circuit may passively discharge the energy to avoid damage to the charge storage assembly and/or other components of the intelligent energy storage device. Further, the intelligent energy storage device includes circuitry (e.g., a processor) to control the components of the intelligent energy storage device such that the intelligent energy storage device stores and delivers electric power, within the physical capabilities of all system components safely and without harm to its individual components. The intelligent energy storage device is described in detail below with reference to FIG. 1.

Referring to FIG. 1, a block diagram of an intelligent energy storage device 100 is shown. According to an embodiment, the intelligent energy storage device 100 includes, but is not limited to, a charge storage assembly 101, at least one processor 103, a passive balancing circuit 105, a protection device 107, a current limiting charging device 109, terminal posts 111, a current measurement assembly 113, a plurality of voltage measurement assemblies, including a first voltage measurement assembly (V1) 117, a second voltage measurement assembly (V2) 105a, and a third voltage measurement assembly (V3) 119, a signal selector (i.e., an ‘OR’ gate) 115, and a main breaker 121.

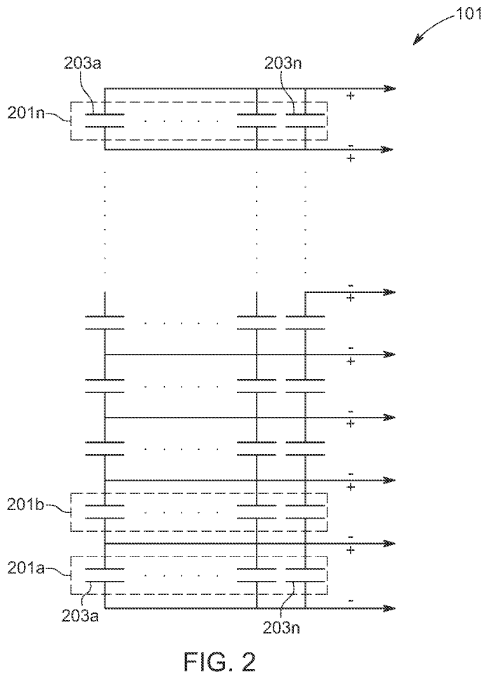

The charge storage assembly 101 includes an array of high-power energy storage devices. For instance, the charge storage assembly 101 includes the array of high-power energy storage device is as illustrated in FIG. 2.

Referring to FIG. 2, a schematic diagram of the charge storage assembly 101 is shown. As illustrated in FIG. 2, the charge storage assembly 101 includes a plurality of strings 201a, 201b . . . 201n. As used herein, the term ‘string’ may refer to a plurality of high-power energy storage devices 203a . . . 203n that are connected in parallel. As used herein, the ‘high-power energy storage device’ may relate to, for example, a supercapacitor, an electric double-layer capacitor (EDLC), a hybrid capacitor, a pseudo-capacitor, or a combination thereof leading to a high-power storage system.

Each string corresponds to an element in the array of the charge storage assembly 101. The plurality of strings 201a, 201b . . . 201n are connected in series to formulate the charge storage assembly 101 as the array of the high-power energy storage devices. In FIG. 2, for exemplary purpose, the charge storage assembly 101 comprising ‘n’ high-power energy storage devices 203a-203n that are connected in a parallel configuration and ‘n’ such parallel configurations of energy storage devices 203a-203n being connected in a series configuration, as strings 201a . . . 201n, is considered. However, the charge storage assembly 101 may be an arrangement of high-power energy storage devices 203a-203n in any combination of series and/or parallel configurations to deliver an electrical energy at a predetermined voltage.

Referring to FIG. 1, the charge storage assembly 101 may be operatively coupled to a hierarchical system of one or more processors 103 and one or more devices 105, 107, 109 to power-up the intelligent energy storage device 100 in a safe and controlled manner. The at least one processor 103 may be embodied in several different ways. For example, the at least one processor 103 may be embodied as one or more of various hardware processing modules such as a coprocessor, a microprocessor, a controller, a digital signal processor (DSP), a processing element with or without an accompanying DSP, or various other processing circuitry including integrated circuits such as, for example, an ASIC, an FPGA, a microcontroller unit (MCU), a hardware accelerator, a special-purpose computer chip, or the like. For example, the at least one processor 103 maybe a computer chip that includes a microcontroller with SPI (Serial Peripheral Interface), UART (Universal Asynchronous Receiver/Transmitter) and any other relevant interfaces that are known in the art. The computer chip may further include a crypto authenticator for network key security, one or more IoT devices that are capable of Bluetooth, Wi-Fi, and SPI communication interfaces. Furthermore, the computer chip may include a current measurement chip, a push button interface, one or more user interface LEDs (Light Emitting Diode), or the like.

In an example embodiment, the at least one processor 103 may be operatively coupled with a memory storing a system safety module 103a. The memory may be embodied as SD (Secure Digital), RAM (Random Access Memory), ROM (Read Only Memory), hard-disk, or any combination thereof. The system safety module 103a represents a set of instructions (e.g., a software code), that is executed by the at least one processor 103. The at least one processor 103, when loaded with the software code, is configured as a special purpose computer to perform algorithms and operations described herein. In an example embodiment, when the system safety module 103a is executed, the at least one processor 103 is configured to control one or more units in the intelligent energy storage device 100. To this end, the at least one processor 103 may be operatively coupled to the one or more units. For instance, the one or more units may include the protection device 107, the current limiting charging device 109, the user interface module 103b, and/or the external input module 103c. As used herein, the ‘control’ may refer to, for example, switching on/off the unit or configuring the unit to perform according to its corresponding operations described herein. Alternatively, the system safety module 103a may be a special purpose hardware, such as an Application Specific Integrated Circuit (i.e., ASIC) or Field Programmable Gate Array (i.e., FPGA) that executes instructions to control one or more of the units (e.g., current limiting charging device 109, the user interface module 103b and/or the external input module 103c).

Protection device. According to an embodiment of the invention, the protection device 107 is a switching device that is operatively connected between the terminal post 111 and the charge storage assembly 101. The terminal posts 111 may be electrical connectors. For instance, the electrical connectors are used to connect a power supply (not shown) to the intelligent energy storage device 100 for charging the charge storage assembly 101. Alternatively, the electrical connectors is used to connect an electrical load (such an electrical vehicle, AC inverter, or the like) to the intelligent energy storage device 100 for powering the electrical load. Both a supply and load may be coupled simultaneously to the terminal posts 111.

The protection device 107 is configured to allow or prevent, according to a first control input received from the at least one processor 103, the flow of the electrical energy into (or out of) the charge storage assembly 101 in a safe manner. For instance, while charging the charge storage assembly 101 or discharging the charge storage assembly 101, the protection device 107 may allow or may not allow the electrical energy to flow into the charge storage assembly 101 based on the first control input received from the at least one processor 103. For instance, the first control input may be a digital signal received from the at least one processor 103. For example, the digital signal may be a sequence of bits or simply a digital one or digital zero. In an example embodiment, upon executing the system safety module 103a, the at least one processor 103 may determine the first control input for the protection device 107. The protection device 107 may be embodied as a SSR (Solid State Relay). For instance, the protection device 107 may include MOSFET drivers, MOSFET's, and one or more heat sink circuits. In one aspect of the invention, the at least one processor 103 operates to always turn ON the protection device 107 (e.g., SSR), for example, by a digital signal of logical 1 to the SSR control circuit and OFF with a digital signal of logical 0 to the SSR control circuit. Alternatively, other methods to control power flow without SSR's may be utilized. For example, a digital circuit breaker may be utilized as protection device 107, without altering the scope of the invention claimed.

Current limiting charging device. Some embodiments are based on the recognition that when the charge storage assembly 101 discharges below a safe operating level, the charge storage assembly 101 should be charged with a limited current to avoid damage to the charge storage assembly 101. To this end, the intelligent energy storage device 100 includes current limiting charging device 109 that is connected in parallel to the protection device 107. For instance, the safe operating level for discharging the charge storage assembly 101 is specified or predetermined based on the configuration of the charge storage assembly 101. Current limiting charging device 109 is operatively coupled between the charge storage assembly 101 and the terminal posts 111.

According to an embodiment, current limiting charging device 109 is configured to limit (e.g., step-down) a voltage from the power supply such that the limited current is drawn from the power supply. In an example embodiment, upon executing the system safety module 103a, the at least one processor 103 may be configured to determine a second control input signal; and control, according to the second control input signal, current limiting charging device 109 to limit the voltage from the power supply such that a limited current is drawn from the power supply. For instance, the second control input signal may be a digital signal. (e.g., a digital or analog “1”) that limits current in both directions for charging and discharging storage assembly 101. Alternatively, when, for example, a digital or analog “0” is received, current flow through the current limiting charging device 109 is prevented. Further, current limiting charging device 109 may be configured to check if there is a short circuit in the terminal posts 111 to avoid damage to the intelligent energy storage device 100. Current limiting charging device 109 may be embodied as a DC-to-DC converter that may include a “Buck”, “Boost” or “Buck and Boost” converter with a predefined current limit. For instance, the current limiting charging device 109 may include MOSFETs, capacitors, and inductors that formulate a DC-to-DC converter configuration with a predefined current limit. Further, current limiting charging device 109 may include MOSFET drivers, PCB (Printed Circuit Board) embedded heat sink, or the like. In alternate embodiments, current limiting charging device 109 may include an in-built charging device that supplies the current of the predefined current limit. In these embodiments, the current limiting charging device 109 supplies the current of the predefined current limit, when the charge storage assembly 101 discharges below the safe operating level, or when it needs to safely match the terminal voltage with the internal charge storage assembly 101 to avoid excessive current flow before the protection device 107 is activated to allow current flow.

Some embodiments are based on the recognition that when a voltage across the charge storage assembly 101 drops below a certain threshold value, the at least one processor 103 may be non-operational or in-operable. As a result, current limiting charging device 109 may not receive the digital second control input signal from the at least one processor 103. In other words, even if the charge storage assembly 101 discharges below the safe operating level, the low-charging current charging device 109 may not receive the second control input signal from the at least one processor 103.

To this end, the intelligent energy storage device 100 includes a selector circuit (e.g., an ‘OR’ gate) 115 that may provide a separate (analog or digital) control signal, independent of the second control signal, to the low-power storage device. In an example embodiment, the ‘OR’ gate 115 is operatively coupled between the at least one processor 103 and the current limiting charging device 109 such that one input terminal of the ‘OR’ gate 115 is connected to the at least one processor 103, another input terminal of the ‘OR’ gate 115 is connected to at least one of the voltage measurement assemblies 117 and/or 119, and an output terminal of the ‘OR’ gate 115 is connected to the current limiting charging device 109. Accordingly, even if current limiting charging device 109 does not receive the second control input signal from the at least one processor 103, current limiting charging device 109 may receive, in this case, a control signal from at least one of the voltage measurement assemblies 117 and/or 119 and limit the current from the power supply such that the limited current is drawn from the power supply, when the voltage across the charge storage assembly 101 drops below a certain threshold value. That is, the current limiting charging device 109 may be automatically switched “on” to limit the voltage from the power supply such that the limited current is drawn from the power supply, when the voltage across the charge storage assembly 101 drops below a known threshold value. For example, the charging voltage provided by the power supply may be reduced to a known percentage (e.g., 90%, 80% or the like) of the charging voltage that provides for a safe charging of the storage assembly 101. Accordingly, current limiting charging device 109 prevents damage to the charge storage assembly 101 and henceforth it is possible to recharge a module that has lost power to the point where the at least one processor 103 is not operational. Alternatively, the limitation to the charging voltage may be dynamically adjusted based on the degree of discharge of the storage assembly. That is, the limitation of charging voltage applied to the storage assembly may be higher (i.e., low voltage) when the voltage of the storage assembly indicates storage assembly 101 is significantly discharged and reduced (i.e., higher voltage) as the storage assembly 101 voltage increases until substantially full charging voltage is applied to the storage assembly 101. That is, the reduction of the charging voltage may be determined based on the voltage of the storage assembly, wherein the reduction in the charging voltage may be greater when a voltage of the storage assembly 101 is near zero and the reduction in the charging voltage may be less when the voltage of the storage assembly 101 is near the known threshold value.

Passive balancing circuit. Some embodiments are based on the recognition that the voltage across the charge storage assembly 101 or voltage across any string assemblies 201 should not exceed a particular voltage value to avoid damage to the charge storage assembly 101 and/or other electrical systems connected to the intelligent energy storage device 100. In order to balance the voltages across the individual strings 201 inside the charge storage assembly 101, the intelligent energy storage device 100 includes the passive balancing circuit 105. For instance, the passive balancing circuit 105 may be coupled between the charge storage assembly 101 and the at least one processor 103.

According to an embodiment, the passive balancing circuit 105 is configured to balance the voltage across the charge storage assembly 101 by bleeding (or discharging) electrical energy from the individual strings 201, when the voltage across the charge storage assembly 101 exceeds the particular voltage value. To this end, the passive balancing circuit 105 may include banks of resistors to passively bleed the electrical energy from the high-power energy storage devices. Further, the passive balancing circuit 105 may include the voltage measurement assembly 105a to measure a voltage across the individual strings 201a-201n and total voltage of the charge storage assembly 101. In one embodiment, the voltage measurement assembly 105a may be embodied as a voltage sensor. Further, the passive balancing circuit 105 may include a processor, such as one or more controllers (such as energy storage cell controllers) or special purpose hardware, which measure the voltage across the charge storage assembly 101 with a daisy chain functionality. Further, the one or more controllers may include an SPI communication interface or any other communication interfaces that are known in the art. In an exemplary embodiment, passive balancing circuit 105 may forward the voltage across each of the plurality of strings 201a-201n, and/or the discharge voltage across the banks of the resistor as a digital signal to the at least one processor 103.

User interface module and external input module. According to an embodiment, the at least one processor 103 may control the external input module 103c to receive voltage measurements from one or more of the voltage measurement assemblies 105a, 117 and 119. Further, the at least one processor 103 may control the external input module 103c to receive current measurements from current measurement assembly 113. In an exemplary embodiment, the voltage measurement assembly 119 may be a voltage sensor that measures a voltage across the terminals 111. In an alternate embodiment, the voltage measurement assembly 105a may be a plurality of voltage sensors, wherein each voltage sensor measures a voltage across one particular string of the charge storage assembly 101 such that a summation of the voltage measurements produces the voltage across the charge storage assembly 101. For instance, the voltage sensor may be a sensor that measures voltage between two terminals and outputs the voltage measurements as an analog or digital signal.

The current measurement assembly 113 may be a current sensor that measures an electric current flowing into (or out of) the charge storage assembly 101. For instance, the current sensor may be embodied as a Hall effect-current sensor, shunt-based current sensor, or any other current sensing technology that is relevant in the art. Some embodiments are based on the realization that a temperature of a unit may increase if there is the short circuit in the unit. To this end, one or more temperature sensors (122, 123, 124) may be installed at the charge storage assembly 101, the protection device 107, and/or the terminal posts 111, respectively. In this exemplary embodiment, the external input module 103c may further receive temperature measurements from the one or more temperature sensors. The external input module 103c may be embodied as a transceiver, ADC (analog to digital converter) or any other relevant transmission and reception device that is known in the art. The current measurement assembly 113 is preferably placed on the circuit between the charge storage assembly 101 and the negative terminal (as indicated by a “−” sign) of terminals 111. This placement reduces cost and improves system efficiency. In further embodiments, the current measurement device may be placed in the circuit between the protection device 107 and the positive terminal (as indicated by “+” sign) of terminal 111.

Further, the at least one processor 103 may control the user interface module 103b to provide the voltage measurements of each high-power energy storage device within storage assembly 101, the temperature measurements at the charge storage assembly 101, the protection device 107, and/or the terminal posts 111. The user interface module 103b is a communication interface between a user and a data storage system for the intelligent energy storage device 100. The user interface module 103b may include one or more modules such as a LED (light emitting diode), an LCD (liquid crystal display), a WI-FI module to connect to the internet, Bluetooth to connect to a mobile device, one or more push buttons, one or more buzzers or the like.

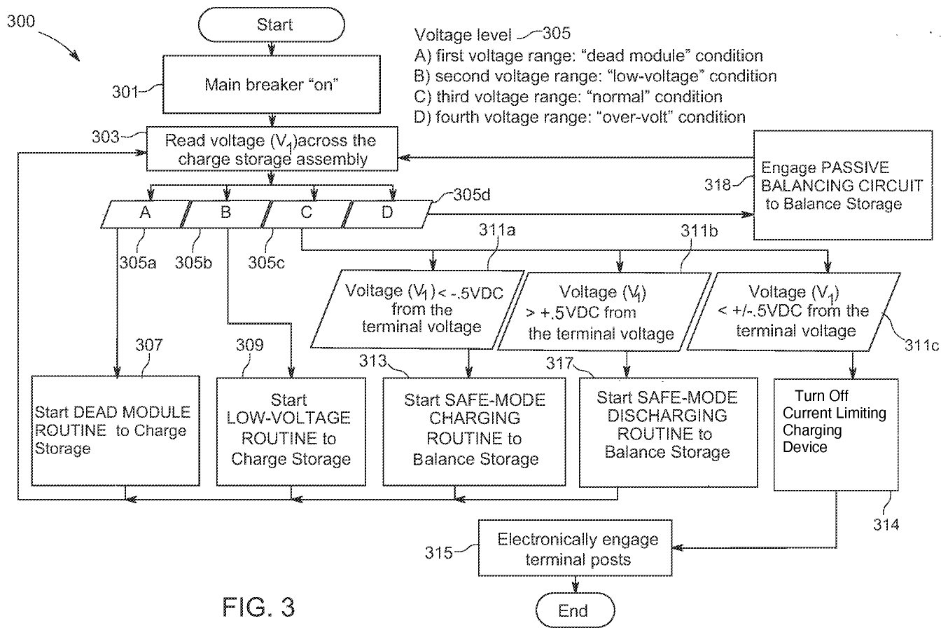

Referring to FIG. 3, a process flow 300 of the intelligent energy storage device 100 is shown. The process flow 300 is explained in conjunction with the intelligent energy storage device 100 described in the detailed description of FIG. 1 and FIG. 2. Starting at block 301, the main breaker 121 may be manually turned on by the user to engage process 300. At block 303, the voltage measurement assembly 117 reads the voltage (V1) across the charge storage assembly 101.

At block 305, the at least one processor 103 may determine an operative condition associated with the charge storage assembly 101, based on the voltage (V1) across the charge storage assembly 101. The operative condition may include a low-voltage condition, a normal condition, and/or an over-voltage condition. In some embodiments, the operative condition may further include a dead module condition. Further, a dead module condition may be a condition where the at least one processor 103 is unable to operate due to low voltage when the voltage (V1) is within a first voltage range 305a. For example, the first voltage range 305a may be 0.00-19.99 VDC (i.e., voltage of direct current). As used herein, the low-voltage condition is a condition where the voltage (V1) is within a second voltage range 305b. For example, the second voltage range 305b may be 20.00-43.99 VDC. As used herein, the normal condition is a condition where the voltage (V1) is within a third voltage range 305c. For example, the third voltage range 305c may be 44.00-54.00 VDC. As used herein, the over-voltage condition is a condition where the voltage (V1) is in a fourth voltage range 305d. For example, the fourth voltage range 305d may be greater than 54.00 VDC. Although specific voltage ranges are disclosed, it would be understood that the voltage ranges disclosed are only exemplary ranges and that other voltage ranges for the different referred to conditions of the storage assembly based on the storage assembly voltage have been contemplated and considered within the scope of the invention claimed.

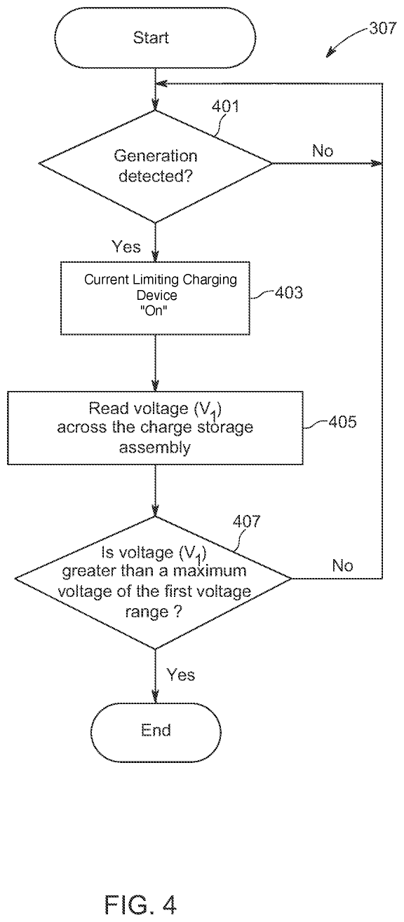

In accordance with the principles of the invention, when the operative condition corresponds to the dead module condition (i.e., storage voltage within said first voltage range), the process flow 300 proceeds to block 307. At block 307, a dead module routine is executed to charge the charge storage assembly 101. An exemplary embodiment of the dead module routine is illustrated in FIG. 4.

Referring to FIG. 4, the flowchart illustrates an exemplary embodiment of the execution of the dead module routine at block 307 in the process flow 300. Starting at block 401, a determination is made whether a charge generation condition is detected by the voltage measurement assembly 119 across terminal 111. For instance, the voltage measurement assembly 119 may send a signal (e.g., digital or analog signal) to one input terminal of the “OR” gate 115, if a power supply (not shown) is connected across the terminal posts 111. For instance, if no charging voltage or power is supplied across the terminal posts 111, the voltage measurement assembly 119 waits until the power supply is connected and a charging voltage is available at terminal posts 111

In response to the detection of a charging voltage at terminal posts 111, at block 403, the current limiting charging device 109 may be turned-on. For instance, the current limiting charging device 109 may be turned-on, as the output of the “OR” gate 115 tends to high, if any of the input terminals of the “OR” gate 115 is high (i.e., the presence of a signal). It would be appreciated the presence of a signal may be determined when a “High” is presented on an input of gate 115. Alternatively, the presence of a signal may be determined when a “Low” is presented on an input of gate 115 (i.e., negative logic). Once current limiting charging device 109 is turned-on, the charge storage assembly 101 may be charged with a limited current to avoid damage to the charge storage assembly 101. In one aspect of the invention, the charging voltage may be limited or reduced by a known percentage (as previously discussed) to avoid too rapid a charging of the storage assembly 101 determined to be in a dead module condition. This is done through, for example, a DC-DC converter that can control the charging voltage in order to control the current that is applied to storage assembly 101.

At block 405, the voltage measurement assembly 117 reads the voltage (V1) across the charge storage assembly 101. At block 407, if the voltage (V1) is not greater than a maximum voltage of the first voltage range 305a (e.g., 19.99 VDC), the dead module routine may automatically proceed to block 401. However, when the voltage (V1) is determined to be greater than the maximum voltage of the first voltage range 305a, the dead module routine may terminate and return to block 303 of process 300. In one aspect of the invention, the maximum voltage of the first voltage range 305a may be determined to be a minimum voltage that enables at least one processor 103 to become operational. For example, a maximum voltage of the first voltage range may be determined to be 19.99 or 20 VDC based on the exemplary voltage ranges disclosed, herein.

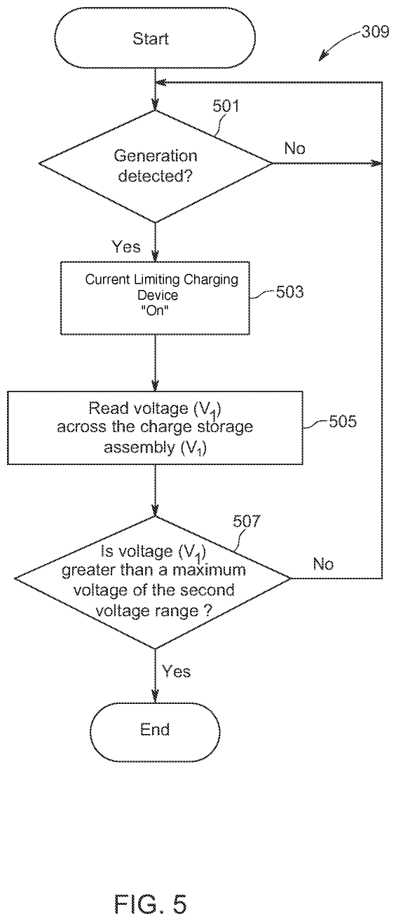

Referring to FIG. 3, once the dead module routine is executed at block 307, the process flow 300 proceeds at block 303. At block 303, the voltage measurement assembly 117 reads the voltage (V1) across the charge storage assembly 101. At block 305, the at least one processor 103 may be configured to determine the operative condition associated with the charge storage assembly 101, based on voltage (V1). When the voltage V1 indicates an operative condition corresponds to the low-voltage condition (i.e., second voltage range), the process flow 300 proceeds to block 309. At block 309, a low-voltage routine is executed to charge the charge storage assembly 101 is executed. For instance, an exemplary embodiment of a low-voltage charge routine is shown in FIG. 5.

Referring to FIG. 5, flowchart of an exemplary embodiment of a low-voltage charging routine at block 309 in the process flow 300 is illustrated. Starting at block 501, the charge generation across terminals 111 may be detected by the voltage measurement assembly 119. For instance, the voltage measurement assembly 119 may send a signal (e.g., digital or analog signal) to one input terminal of the “OR” gate 115, when the power supply (not shown) is connected across the terminal posts 111. For instance, when the power supply is not connected across the terminal posts 111, the voltage measurement assembly 119 waits until a power supply is connected.

At block 503, the current limiting charging device 109 may be turned-on based at least on the input condition provided to gate 115. Once the current limiting charging device 109 is turned-on, the charge storage assembly 101 is charged with a limited current to avoid damage to the charge storage assembly 101. For example, the charging voltage (or current) may be reduced for example, by 50 percent in this low voltage condition, to allow for the slow charging of storage assembly 101.

At block 505, the voltage measurement assembly 117 reads the voltage (V1) across the charge storage assembly 101. At block 507, the at least one processor 103 may check whether the voltage (V1) is greater than a maximum voltage of the second voltage range 305b. If the voltage (V1) is not greater than the maximum voltage of the second voltage range 305b, the low-voltage charging routine proceeds to block 501. When the voltage (V1) across the storage assembly 101 is greater than a maximum voltage of the second voltage range 305b, the low-voltage charging routine ends and the process returns to block 303 of process 300. For example, the maximum voltage of the second voltage range 305b may be 44.00 VDC, based on the exemplary voltage ranges disclosed, herein. According to the principles of the invention, in a low voltage condition, (e.g., 20V to 44V) the at least one processor 103 will hold the current limiting charging device active via digital signal, to ensure a slow charge up of storage assembly 101. In accordance with the principles of the invention, the current limiting charging device remains active from the dead module to and through the end of low voltage range (as presented in the exemplary voltage ranges discussed, herein.

When the voltage of storage assembly 101 indicates an operative condition, which in this exemplary discussion corresponds to a normal condition or the third voltage range 305c, the process flow 300 proceeds with one of blocks 311a-311c. At block 311a, the at least one processor 103 will check whether the voltage (V1) deviates more than a safe voltage window from the charging voltage (V3)) available at terminal posts 111 to the capacitor module voltage at 117 across the storage assembly 101. In one aspect of the invention, a safe voltage window may be set to +2.0% of the nominal voltage of the charge storage assembly 101. In another aspect of the invention, the safe voltage window, may be set to +1.0% of the nominal voltage of the charge storage assembly 101, and in still another embodiment of the invention, the safe voltage window may be set to +0.75% of the nominal voltage of the charge storage assembly 101. In one aspect of the invention, the nominal voltage may be defined as a fixed, expected value, or as the arithmetic mean of the upper and lower voltage of the third voltage range 305c. For example, with an exemplary lower and upper voltage values for the third voltage range 305c of 44.0 VDC and 54.0 VDC, respectively, a nominal voltage may be defined as (44.0 VDC+54.0 VCD)/2, or (98.0 VDC)/2, or 49.0 VDC. Accordingly, safe voltage windows may, for example, be determined as +0.980 VDC, +0.490 VDC, and +0.0.245 VDC, respectively.

The intelligent energy storage device 100 may incorporate charge storage assemblies 101 of virtually any nominal voltage, such as, for example, ranging from a nominal voltage of 0.10 VDC to a nominal voltage of 1,000.0 VDC. In the exemplary embodiment of the intelligent storage device 100 shown in FIG. 1, the nominal voltage for the charge storage assembly 101 may be selected to be, for example, and for purposes of describing the invention claimed, 48.0 VDC. Accordingly, a safe voltage window of the intelligent storage device 100 shown in FIG. 1 may be determined as ±1.04% of the nominal voltage (i.e., 48 VDC), or ±0.50 VDC. Returning to FIG. 3, at block 311a, the at least one processor 103 may check whether the voltage (V1) is less than the lower bound of the safe voltage window from the terminal (or charging) voltage (V3) at voltage measurement device 119. That is voltage 117(V1) has a value that is lower than the safe voltage window (i.e., −0.50 VDC) of (e.g., in the negative direction) the terminal voltage (V3). At block 311b the at least one processor 103 may check whether the voltage (V1) is greater than the safe voltage window (e.g., +0.5 VDC) of (in the positive direction) the terminal voltage (V3). At 311c the at least one processor 103 may further determine whether the voltage (V1) is within the safe voltage window (e.g., +/−0.5 VDC) from the terminal voltage (V3).

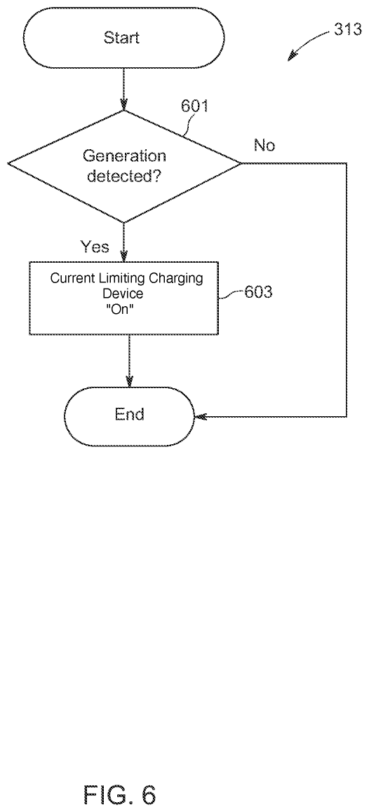

When, at block 311a, the voltage (V1) is further than-0.5 VDC from the terminal voltage (more than 0.5 VDC in the negative direction), such as a V1−V3 value of −0.70 VDC, for example, the process flow 300 may proceed with block 313. At block 313, the safe-mode charging routine may be executed to charge the charge storage assembly 101. For instance, an exemplary embodiment of a safe-mode charging routine is illustrated in FIG. 6.

Referring to FIG. 6, the flowchart illustrates an exemplary embodiment a safe-mode charging routine at block 313 in the process flow 300. Starting at block 601, the presence of a charging voltage at terminal posts 111 may be detected by the voltage measurement assembly 119. For instance, the voltage measurement assembly 119 may send a signal (e.g., digital or analog signal) to one input terminal of the “OR” gate 115, when a power supply is connected across the terminal posts 111. For instance, when the power supply is not connected across the terminal posts 111, the voltage measurement assembly 119 waits until the power supply is connected. Alternatively, the process may go to the end of the 313 subroutine and continue back to block 303 to again read the voltage (V1) across the charge storage assembly. When at block 601, generation is detected, at block 603, at least one processor 103 may turn “ON” the current limiting charging device 109 by the generation of second control input, wherein the second control input causes the current limiting charging device 109 to charge, in a controlled manner, the storage assembly 101 from the voltage present at terminals 111 with a limited current. For example, 30% or the like reduction in the voltage present at terminal 111. The limitation of the current to storage assembly 101 prevents damage to the storage assembly 101, when the voltage connected to the terminal posts 111 is not within a safe voltage compared to the internal module voltage. The second control signal ensures the low power charging routine remains in an “active” condition until the safe connection window is reached at block 314. In accordance with the principles of the invention, the safe charging module reduces or limits the current to the storage assembly 101 to prevent damage to the storage assembly 101 by too rapid a charging rate.

Alternatively, or additionally, at block 603, current limiting charging device 109 may be automatically turned-on when generation (i.e., a power supply at terminal posts 111) is detected in block 601. For instance, current limiting charging device 109 may be automatically turned-on, as an output of the “OR” gate 115 tends to be in a state indicating a signal is present via at least one of the input terminals of the selector circuit 115. Once current limiting charging device 109 is turned-on, the charge storage assembly 101 may be charged with a limited current to avoid the damage to the charge storage assembly 101. Once the current limiting charging device is turned on, the process may proceed to block 313 and continue back to block 303 to again read the voltage (V1) across the charge storage assembly 101,

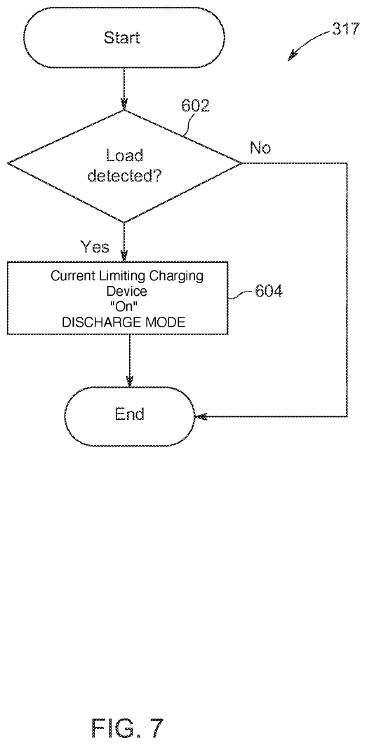

Continuing, when the voltage (V1) across the charge storage assembly is read at block 303, when, at block 311b, the voltage (V1) is greater than the upper bound of the safe window (e.g., +0.5 VDC) above the terminal voltage), the process flow 300 may proceed to block 317. At block 317, the safe-mode discharging routine may be executed to discharge the charge storage assembly 101. An exemplary embodiment of a safe-mode discharging routine is illustrated in FIG. 7.

Referring to FIG. 7, the flowchart illustrates an exemplary embodiment of a safe-mode discharge routine using current limiting charging device 109, wherein at block 602, a load may be detected at terminals 111 by voltage measurement assembly 119. For instance, the voltage measurement assembly 119 may send a signal (e.g., digital or analog signal) to one input terminal of the “OR” gate 115, when a load is connected across the terminal posts 111. For instance, when a load is not connected across the terminal posts 111, the voltage measurement assembly 119 may wait until a load is connected. Alternatively, the process may proceed to the end of the safe mode discharge routine (317) and continue back to block 303 to again read the voltage (V1) across the charge storage assembly 101. When load is detected, at block 604, the at least one processor 103 may turn “ON” the current limiting charging device 109 in discharge mode.

Alternatively, or additionally, at block 604, the current limiting charging device 109 may be automatically turned-on in discharge mode when load is detected in block 602. Once current limiting charging device 109 is turned-on, the charge storage assembly 101 may be discharged with a limited current to avoid damage to the charge storage assembly 101. Once current limiting charging device 109 is turned on, the safe mode discharging routine may proceed to the end of the safe mode discharge routine (317) and continue back to block 303 to again read the voltage (V1) across the charge storage assembly. In accordance with the principles of the invention, and solely for the discussion of presenting the invention claimed in a concise manner, the current limit established by the current limiting charging device may be set to between 0.5 A and 5 A so as to maintain a constant and safe current output.

When the voltage (V1) across the charge storage assembly is read at block 303, and, at block 311c, the voltage (V1) is determined to be within the safe voltage window from the terminal voltage, (e.g., +/−0.5 VDC in the exemplary embodiment disclosed), the process flow 300 may proceed to block 314. At block 314 the system will turn off the current limiting charging device 109 and proceed to block 315, where the at least one processor 103 electronically engages through protection device 107 by the at least one processor 103 turning “ON” protection device 107 by the issuance of the first control signal and turning “OFF” the current limiting charging device 109 by the issuance of the second control signal, storage assembly 101 to terminal posts 111. Once the terminal posts 111 are engaged in step 315, current from storage device 101 to terminal posts 111 or from terminal posts to storage device 101 is provided through protection device 107 in a manner that provides for safe operation of the equipment of the intelligent storage system 100 and/or devices (not shown) attached to terminals 111 of system 100. For example, the above process eliminates current surges across the equipment by matching the terminal voltage with the charge storage assembly 101 voltage before switching on the protection device 107. The process of main routine 300 returns to step 301 or, preferably, step 303, to again read the voltage (V1) across the charge storage assembly 101.

When the voltage (V1) across the charge storage assembly is read at block 303, and the operative condition corresponds to the fourth voltage range 305d, (i.e., the over-voltage condition), the process flow 300 may proceed to block 318. At block 318, passive balancing circuit 105 may be engaged to passively discharge the charge storage assembly 101. Once, charge storage assembly 101 is discharged to a nominal voltage level, e.g., a level that corresponds to the third voltage range 305c, the process flow 300 may proceed to block 303.

On implementing the process flow 300, the intelligent energy storage device 100 may balance and control the flow of the energy in the intelligent energy storage device 100 such that the intelligent energy storage device 100 operates to safely store and deliver energy, within the physical capabilities of all system components and without harm to its individual components.

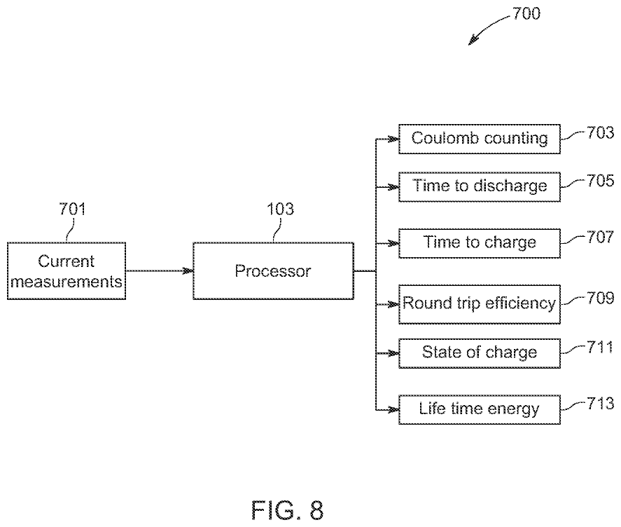

Referring to FIG. 8, a block diagram 700 showing one or more computations performed by the at least one processor 103 using current measurements 701 is illustrated. FIG. 8 is explained in conjunction with FIG. 1. The current measurements 701 may correspond to the current measurements obtained from the current measurement assembly 113. In a preferred embodiment, the current measurement assembly 113 may be a shunt-based current sensor that accurately measures the current flowing-in or flowing-out of the charge storage assembly 101.

At block 703, the at least one processor 103 may be configured to determine coulomb counting. In order to determine the coulomb counting, the at least one processor 103 may receive from the current measurement assembly 113 via the external input module 103c, multiple measurements of the current for a predefined time period (e.g., 1.0 second). Further, the at least one processor 103 may compute an average of the multiple measurements to keep track of energy flow in and out of the storage assembly 101, known in the art as coulomb counting.

At block 711, the at least one processor 103 may be configured to determine a state of charge (SOC) of storage assembly 101. In an example embodiment, the at least one processor 103 may determine the state of charge (SOC), by use of mathematical formulas and coulomb counting. For instance, the state of charge may be mathematically determined as: Calibrate energy when module full to SOC 100%. SOC (current)=SOC (calibrated 100%)−((energy discharged out of storage assembly 101−energy charged to storage assembly 101)/module capacity)*100.

At block 705, the at least one processor 103 may be configured to determine a time to discharge. In an example embodiment, the at least one processor 103 may determine the time to discharge, based on the state of charge (SOC). As used herein, the time to discharge may indicate a time period up to which the intelligent energy storage device 100 can discharge. For instance, the time to discharge may be determined based on the state of charge and a current rate of discharge. For example, the time to discharge may be a value given as seconds, minutes, hours, days or a combination thereof. Time to discharge is calculated as amount of charge in the intelligent energy storage device/current rate of discharge (using Coulomb counting described above). For instance, if the amount of charge in the intelligent energy storage device is 3 kWh, and the rate of discharge is 0.5 kW, then the time to discharge is 6 hours.

At block 707, the at least one processor 103 may be configured to determine a time to charge. In an example embodiment, the at least one processor 103 may determine the time to charge, based on the state of charge and the current rate of charge. As used herein, the time to charge may indicate a time period that the intelligent energy storage device 100 requires to fully charge. For example, the time to charge may provide information about a time required to charge the intelligent energy storage device 100 from zero percentage to one-hundred percentage. Time to charge for the intelligent energy storage device is calculated as (full charge amount-current charge amount)/current rate of charge (using Coulomb counting described above). For instance, if the amount of charge in the intelligent energy storage device is 0.5 kWh, and the rate of charge is 0.5 kW, then the time to full charge is 6 hours.

At block 709, the at least one processor 103 may be configured to determine a round trip efficiency. In an example embodiment, the at least one processor 103 may determine the round-trip efficiency, based on the coulomb counting. In order to determine the round-trip efficiency, the at least one processor 103 may determine, from the coulomb counting, the total amount of energy that has been charged into the storage device 100 during its life. Further, the at least one processor 103 may determine, from the coulomb counting, a second total amount of energy that has been discharged from the intelligent energy storage device 100 in its life. Furthermore, the at least one processor 103 may compute a ratio of the second amount of energy to the first amount of energy, to determine the round-trip efficiency. For example, if the total amount of energy that has been charged into the intelligent energy storage device 100 is 100 kWh, and the total amount of energy discharged from the intelligent energy storage device 100 is 98 kwh, then the round-trip efficiency is 98 kWh/100 kWh, or 98%.

At block 713, the at least one processor 103 may be configured to determine a lifetime energy. In an example embodiment, the at least one processor 103 may determine the lifetime energy, based on the coulomb counting. As used herein, the lifetime energy may indicate an amount of energy that the charge storage assembly 101 stores and/or delivers throughout the lifetime of the or intelligent energy storage device 100. This information may be stored in a memory device and used in calculations in at least one processor 103 and may be made available to a user through the user interface module 103b.

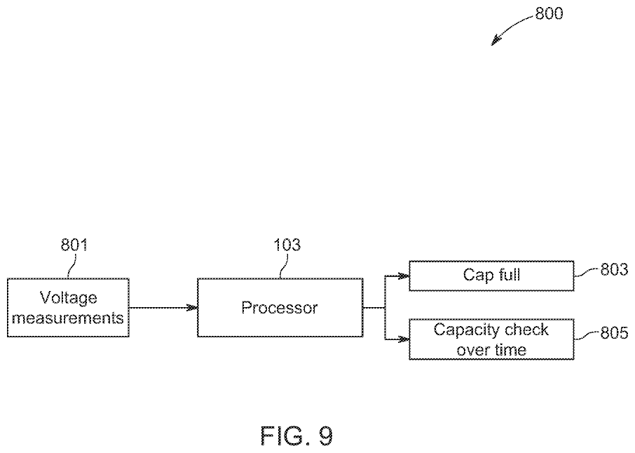

Referring to FIG. 9, a block diagram 800 showing one or more computations performed by the at least one processor 103 using voltage measurements 801 is illustrated. FIG. 9 is explained in conjunction with FIG. 1. The voltage measurements 801 may correspond to the voltage measurements obtained from the voltage measurement assembly 117. For instance, the voltage measurements 801 may be accurate measurements of the voltage across each string of the charge storage assembly 101. For example, the accuracy of the voltage measurements may be up to three, four, and five decimal places (e.g., to the thousandth, the ten-thousandth, and hundred-thousandth Volt).

At block 803, the at least one processor 103 may be configured to determine a “CAP FULL” condition. As used herein, the CAP FULL condition may relate to a condition where a capacity of the charge storage assembly 101 to store the energy is saturated. In order to determine the CAP FULL condition, the at least one processor 103 may determine, from the voltage measurements 801, the voltage across the charge storage assembly 101. Further, the at least one processor 103 may determine, from the voltage measurements 801, a power associated with the charge storage assembly 101. Furthermore, the at least one processor 103 may determine a time for which the charge storage assembly 101 slows or does not in-take the charge. Furthermore, the at least one processor 103 may be configured to determine the CAP FULL condition, based on one or more of the voltage across the charge storage assembly 101, the power associated with the charge storage assembly 101, and/or the time for which the charge storage assembly 101 slows or does not in-take the charge. For instance, the at least one processor 103 may determine the CAP FULL condition, if the voltage across the charge storage assembly 101 is greater than or equal to the nominal voltage of the charge storage assembly and the power intake of the charge storage assembly 101 is less than a predetermined percentage of the capacity of the charge storage assembly 101; and the time for which the charge storage assembly 101 slows or does not in-take the charge is equal to a preset amount and time.

In an example embodiment, the at least one processor 103 may control the protection device 107, based on the CAP FULL condition. For instance, the at least one processor 103 may determine the first control input to switch-off the protection device 107, when the CAP FULL condition is positive. Thereby, the at least one processor 103 may prevent the over-voltage condition while charging the charge storage assembly 101.

In summary, a method of operation of the intelligent device 100 may include the steps of:
1) determining a storage assembly voltage;
2) initiating a dead module process based on said storage assembly voltage being below a first voltage, said dead module process passing a first step-downed level of a charging voltage to the storage assembly until said storage assembly voltage exceeds the first voltage;
3) initiating a low-voltage process based on the storage assembly voltage being above the first voltage, the low voltage process is passing a second step-downed level of the charging voltage to the storage assembly until the storage assembly voltage exceeds the charging voltage;
4) initiating one of: a charging process based on the storage assembly voltage and the charging voltage, wherein the storage assembly voltage is a first tolerance value below the charging voltage and a discharging process based on said storage assembly voltage being within a second tolerance level above the charging voltage, wherein a balancing process is concurrently performed during the discharging process to balance electrical energy distribution from electrical storage elements of the storage assembly.

Some embodiments are based on the realization that the one or more strings in the charge storage assembly 101 may be or may become degraded due to manufacturing defects or may be or may become damaged over time due to external factors. As a result, a capacity loss may occur in one or more strings in the charge storage assembly 101, and these strings may therefore perform differently on a relative basis when compared to those that are functioning normally. For instance, if two strings are degraded in the charge storage assembly 101 comprising twenty strings, these two strings will discharge more quickly, causing the voltage to drop faster than the other strings. This rapid drop will cause the module to shut down sooner than under normal conditions, resulting in a significant loss of capacity for the charge storage assembly 101.

To this end, at block 805, the at least one processor 103 may be configured to perform the capacity check over time. In order to perform the capacity check over time, the at least one processor 103 may be configured to determine a time that each string takes to reach a shutdown voltage (e.g., 2.20 VDC) after reaching a discharge voltage (e.g., 2.30 VDC). Further, the at least one processor 103 may compare the determined time taken by each string with a relative time. Furthermore, the at least one processor 103 may identify the one or more strings that discharge faster than the relative time as the unbalanced strings.

Furthermore, the at least one processor 103 may be configured to determine a capacity loss in the charge storage assembly 101 by using the coulomb counting and/or the voltage measurements 801. Furthermore, the at least one processor 103 may be configured to check if the capacity loss is greater than a threshold capacity loss. If the capacity loss is greater than the threshold capacity loss, the at least one processor 103 may control the user interface module 103b to provide, to the user, information about the unbalanced strings. For instance, the user may manually add one or more high-power energy storage devices to the unbalanced strings to restore the capacity of the charge storage assembly 101. In this way, the at least one processor 103 identifies the unbalanced strings in the charge storage assembly 101 by performing the capacity check over time. Further, the at least one processor 103 may aid in restoring the capacity of charge storage assembly by providing information about the unbalanced strings to the user.

In accordance with the principles of the invention, an intelligent storage system is disclosed that incorporates a current limiting charging device that is provided with either a digital control signal from a processor or an analog control signal, which is available when the processor is not able to provide the digital control signal, where the current limiting charging device prevents damage to the storage assembly by limiting the current into the storage assembly to a predetermined value when a voltage at a terminal is higher than a safe connection value during the storage system activation. The current limiting charging device further prevents damage to the storage assembly and terminal connected equipment provides for the safe recovery during a “dead module” condition by limiting the current into the storage assembly to a predetermined value when a voltage source is connected to the terminals while the processor is in an inactive condition. Accordingly, the current limiting charging device makes activation of the intelligent storage system into existing systems safe and easy by first using the current limiting charging device to match terminal voltage 111 to charge storage assembly 101 before allowing the passage of current through protection device 109. Accordingly, the intelligent storage assembly disclosed provides for safe and efficient distribution of stored energy to connected devices.

Many modifications and other embodiments of the inventions set forth herein will come to mind to one skilled in the art to which these inventions pertain having the benefit of the teachings presented in the foregoing descriptions and the associated drawings. It is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

The invention illustratively disclosed herein suitably may explicitly be practiced in the absence of any element which is not specifically disclosed herein. While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. The present disclosure also contemplates other embodiments “comprising,” “consisting of” and “consisting essentially of,” the embodiments or elements presented herein, whether explicitly set forth or not. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items, while only the terms “consisting of” and “consisting only of” are to be construed in the limitative sense.

What is claimed is:

1. An electrical storage system comprising:
a storage assembly configured to store electrical energy,
a processor configured to control a charging of said storage assembly, and
a current limiting charging device configured to control at least the charging of said storage assembly based on a charging voltage applied to a plurality of terminals associated with said electrical storage system, said current limiting charging device configured to limit said charging voltage to said storage assembly based on a storage assembly voltage being insufficient to power said processor.

2. The electrical storage system of claim 1, further comprising a selector circuit configured to activate said current limiting charging device.

3. The electrical storage system of claim 2, wherein said selector circuit is configured to receive at least one of a voltage associated with said storage assembly, a voltage associated with said plurality of terminals, and a control signal provided by said processor.

4. The electrical storage system of claim 1, wherein said processor is configured to provide a control signal to said current limiting charging device, and wherein said control signal causes said current limiting charging device to limit a discharge voltage from said storage assembly.

5. The electrical storage system of claim 1, wherein said processor is configured to provide a control signal to said current limiting charging device, and wherein said control signal causing said current limiting charging device to limit said charge voltage to said storage assembly.

6. The electrical storage system of claim 1 further comprising a protection circuit in parallel to said current limiting charging device, wherein said processor is configured to provide a first control signal to said protection circuit, and wherein said protection circuit control performs at least one of a discharge of said storage device and a charging of said storage device based on said first control signal.

7. An electrical storage system configured to perform one of outputting a discharge voltage and receiving a charging voltage, said electrical storage system comprising:
a charge storage assembly comprising a plurality of electrical energy storage elements,
a protection circuit configured to control at least one of outputting said discharge voltage from said storage assembly and applying said charging voltage to said storage assembly,
a current limiting charging device, in parallel to said protection circuit and configured to control said received charging voltage applied to said storage assembly, and
at least one processor configured to receive said voltage associated with said charge storage assembly, provide a first indication to said protection circuit, and provide a second indication to said current limiting charging device, wherein said processor manages one of said output of said discharge voltage and said receiving of said charging voltage based at least on said voltage associated with said charge storage assembly.

8. The electrical storage system of claim 7, further comprising a balancing circuit configured to receive electrical energy from said plurality of energy storage elements and balance said received electrical energy from said storage elements to output said discharge voltage.

9. The electrical storage system of claim 7, further comprising a selection circuit configured to receive as inputs at least one of said charging voltage, said storage assembly voltage and said first indication, and pass at least one of said inputs to said current limiting charging device.

10. The electrical storage system of claim 7, wherein said current limiting charging device is configured to step-down said received charging voltage to be applied to said storage assembly when said storage assembly voltage is below a known threshold.

11. The electrical storage system of claim 7, further comprising a first voltage measurement device configured to measure said voltage associated with said storage assembly, and a second voltage measurement device configured to measure said voltage associated with said charging voltage.

12. The electrical storage system of claim 7, wherein said protection circuit is configured to control one of said discharge voltage out of said storage assembly and said received charging voltage to said storage assembly based on said first indication.

13. The electrical storage system of claim 7, wherein said current limiting charging device is configured to control one of said discharge voltage out of said storage assembly and said received charging voltage to said storage assembly based on said second indication.

14. The electrical storage system of claim 7, further comprising a user interface configured to provide information regarding said electrical storage system to a user, and an external input module configured to receive at least said charging voltage.

15. The electrical storage system of claim 7, further comprising at least one temperature sensor configured to measure a temperature of at least said storage assembly.

16. An electrical storage system comprising:
a pair of electrical terminals,
a storage assembly comprising a plurality of electrical storage elements, and
a management device configured to control a discharge voltage from said storage assembly to said electrical terminals and a charging voltage from said electrical terminals to said storage assembly, said management device comprising
a processor configured to determine control instructions based on at least one of a storage assembly voltage and a charging voltage present at said electrical terminals,
a protection device configured to receive a first control instruction from said processor and direct one of said storage assembly voltage to said terminals and said charging voltage at said terminals to said storage assembly, and
a current limiting charging device configured to receive a second control instruction from said processor and direct one of said storage assembly voltage to said terminals and said charging voltage at said terminals to said storage assembly, wherein when said storage voltage is less than a first threshold stepping down said charging voltage passed to said storage assembly.

17. The electrical storage system of claim 16, further comprising a passive balancing circuit configured to balance the electrical energy stored in said electrical storage elements within said storage assembly.

18. The electrical storage system of claim 16, further comprising a selector circuit configured to receive as input at least one of said storage assembly voltage and said charging voltage, and provide an output of said selector circuit to said current limiting charging device, wherein said current limiting charging device is configured to direct said a limited charging voltage to said storage assembly when said storage voltage is below said first threshold.

19. The electrical storage system of claim 16, wherein said electrical storage elements comprise at least one of a supercapacitor, an electrical double-layer capacitor, a hybrid capacitor, and a pseudo-capacitor.

20. The electrical storage system of claim 19, wherein said electrical storage elements are arranged in a plurality of strings in parallel.
